(19) United States
(12) Patent Application Publication
(10) Pub. No.: US 2012/0232994 A1
(43) Pub. Date: Sep. 13, 2012

(54) METHOD AND SYSTEM FOR PROVIDING LOCATION-BASED ADVERTISEMENT CONTENTS

(75) Inventors: Sung Chan KIM, Suwon-si (KR); Jae Hwan KIM, Suwon-si (KR); Jang Hyun YOON, Yongin-si (KR)

(73) Assignee: SAMSUNG ELECTRONICS CO. LTD., Suwon-si (JP)

(21) Appl. No.: 13/413,128

(22) Filed: Mar. 6, 2012

(30) Foreign Application Priority Data
Mar. 9, 2011 (KR) 10-2011-0020811

(51) Int. Cl. G06Q 30/02

(52) U.S. Cl. 705/14.58

(57) ABSTRACT

A method and system for providing location-based advertisement contents based on objective reliability are provided. In the system, an advertisement server receives check-in counts accumulated as visitors visit a place and check in to the place, and stores them in a place check-in database (DB). The advertisement server extracts a check-in count of a corresponding place corresponding to a location of the advertisement contents from the place check-in DB when the advertisement consumer's mobile device requests advertisement contents and the check-in count from the advertisement server. The advertisement sever transfers the advertisement contents and the extracted check-in count to the advertisement consumer's mobile device.

### PRIORITY

This application claims the benefit under 35 U.S.C. §119(a) of a Korean patent application filed on Mar. 9, 2011 in the Korean Intellectual Property Office and assigned Serial No. 10-2011-0020811, the entire disclosure of which is hereby incorporated by reference.

### BACKGROUND OF THE INVENTION

1. Field of the Invention

The present invention relates to advertisement systems. More particularly, the present invention relates to a method and system for providing location-based advertisement content based on objective reliability.

2. Description of the Related Art

With the development of electronic communication technology, mobile devices are being equipped with a variety of user functions. For example, smart phones allow users to install and delete a variety of applications, compared to mobile phones that only provide a user with basic functions. In addition, smart phones can directly connect to the Internet via Wi-Fi system, so they have become increasing popular.

A social networking program, which allows users to establish personal networks on the web, is one of the popular applications. For example, foursquare is an application that allows users to check-in to a physical place and to be a mayor of a corresponding physical place according to the check-in counts. When a user becomes a mayor of a physical place, for example, a cafeteria, he/she can have a complimentary beverage or make purchases at a discounted price. Since foursquare encourages users to compete to become the mayor of a corresponding place, it is called a dice game via Social Networking Service (SNS). In addition to foursquare, there are other applications that provide a check-in count service such as Gowala, Brightkite, Seeon, etc.

Advertisement systems register advertisement sponsors' advertisement contents and provide them, sometimes processed, to users. Targets of advertisement contents may be divided into items that do not contain locations, such as products, brands, etc. and items that contain locations.

In general, location-based advertisement contents providing systems receive feedback regarding a physical location that will be an advertisement target, i.e., evaluations, from users, grade it with points, and then provide it to the users. That is, the systems receive users' evaluations regarding a corresponding physical location from the users' mobile devices, calculate an average based on the received evaluations, grade it via the average, and then provide the average or the grade to the users.

However, conventional location-based advertisement contents providing systems are disadvantageous in that, since they grade a corresponding physical location based on users' subjective evaluations, they cannot provide location-based advertisement contents based on an objective reliability to users. For example, regarding a restaurant, some users may award ‘100’ points based on food taste and others may award ‘0’ points based on interior décor.

### SUMMARY OF THE INVENTION

Aspects of the present invention are to address at least the above-mentioned problems and/or disadvantages and to provide at least the advantages described below. Accordingly, an aspect of the present invention is to provide a method and system for providing location-based advertisement contents based on objective reliability, via a check-in count service.

In accordance with an aspect of the present invention, a method for providing location-based advertisement contents is provided. The method includes receiving, by an advertisement server, advertisement contents and a location of the advertisement contents from an advertisement sponsor's mobile device, and transferring the location, by the advertisement server, to a check-in count server. The advertisement sever receives a place corresponding to the location from the check-in count server that received the location. When the advertisement server receives a number of places from the check-in count server, it transfers them to the advertisement sponsor's mobile device. When the sponsor selects one of the places, the advertisement server matches the selected place with the location. When the advertisement server receives one place from the check-in count server, it matches the place with the location. The advertisement server requests the check-in count of the place matching the location from the check-in count server. The advertisement server receives the check-in count and the receiving time from the check-in count server and stores them in a place check-in database (DB). The advertisement server calculates the check-in count by time periods using a number of check-in counts and their receiving times stored in the place check-in DB, and creates graphs of the check-in counts by time periods. The advertisement server arranges a number of check-in counts, stored in the place check-in DB, according to the receiving time, and creates graphs of the arranged check-in counts. The advertisement server transfers the advertisement contents and the graphs to an advertisement consumer's mobile device.

In accordance with another aspect of the present invention, a method for providing a location-based advertisement contents is provided. The method includes receiving, by an advertisement server, advertisement contents and a location of the advertisement contents from an advertisement sponsor's mobile device, and transferring, by the advertisement server, the location to a check-in count server. The advertisement sever receives a place corresponding to the location from the check-in count server that received the location. When the advertisement server receives a number of places from the check-in count server, it selects one of them, closest to the location, and matches the selected location with the location. When the advertisement server receives one place from the check-in count server, it matches the place with the location. The advertisement server requests the check-in count of the place matching the location from the check-in count server. The advertisement server receives the check-in count and the receiving time from the check-in count server and stores them in a place check-in DB. The advertisement server calculates the check-in count by time periods using a number of check-in counts and their receiving times stored in the place check-in DB, and creates graphs of the check-in counts by time periods. The advertisement server arranges a number of check-in counts, stored in the place check-in DB, according to the receiving time, and creates graphs of the arranged check-in counts. The advertisement server transfers the advertisement contents and the graphs to an advertisement consumer's mobile device.

In accordance with another aspect of the present invention, a method for providing a location-based advertisement contents is provided. The method includes determining, by the advertisement server, ranks of a number of check-in counts, stored in a place check-in DB, according to fields or local areas. The advertisement server transfers the ranks determined according to fields or local areas to an advertisement consumer's mobile device. The advertisement server arranges a list of advertisement contents in ascending or descending order according to the ranks determined by fields or local areas, and transfers it to the advertisement consumer's mobile device. The advertisement server receives a check-in regarding the advertisement contents from the advertisement consumer's mobile device, counts the check-in, and stores the check-in count in an advertisement check-in DB.

In an exemplary implementation, the advertisement server may add a check-in count, stored in the place check-in DB, and a check-in count stored in the advertisement check-in DB, or separate them.

In accordance with another aspect of the present invention, a system for providing a location-based advertisement contents is provided. The system includes an advertisement sponsor's mobile device, an advertisement consumer's mobile device, a visitor's mobile device, an advertisement server, a check-in count server, and a DB server. The advertisement sponsor's mobile device transfers advertisement contents and a location of the advertisement contents to the advertisement server. The advertisement consumer's mobile device downloads and displays the advertisement contents from the advertisement server. The visitor's mobile device transfers, when the visitor checks in to his/her visited place, the check-in to the check-in count server. The advertisement server requests a check-in count of a place corresponding to the location of the advertisement contents from the check-in count server, and transfers the check-in count, transferred from the check-in count server, and the advertisement contents to the advertisement consumer's mobile device. The check-in count server counts the check-in transferred from the visitor's mobile device. The DB server includes an advertisement contents DB for storing the advertisement contents, and a place check-in DB for storing the check-in counts transferred from the check-in count server.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will become more apparent from the following description taken in conjunction with the accompanying drawings, in which:

FIG. 1 illustrates a network configuration of a location-based advertisement contents providing system according to an exemplary embodiment of the present invention;

FIG. 2 illustrates a flowchart that describes a location-based advertisement contents providing method according to an exemplary embodiment of the present invention;

FIG. 3 illustrates a screen of an advertisement sponsor's mobile device that describes a process of registering a location of advertisement contents to an advertisement server, according to an exemplary embodiment of the present invention;

FIG. 4A illustrates a flowchart that describes an example of selecting and matching a place according to an exemplary embodiment of the present invention;

FIG. 4B illustrates a flowchart that describes another example of selecting and matching a place according to an exemplary embodiment of the present invention;

FIGS. 5A and 5B illustrate a flowchart that describes providing advertisement contents and check-in counts according to an exemplary embodiment of the present invention;

FIG. 6A illustrates a screen of an advertisement consumer's mobile device that describes an example of requesting an advertisement contents view according to an exemplary embodiment of the present invention;

FIG. 6B illustrates a screen of an advertisement consumer's mobile device that describes another example of requesting an advertisement contents view according to an exemplary embodiment of the present invention;

FIG. 7 illustrates a screen of an advertisement consumer's mobile device that describes requesting a check-in view and a check-in according to an exemplary embodiment of the present invention; and

FIGS. 8A and 8B illustrate a screen of an advertisement consumer's mobile device displaying a check-in count that an advertisement server transfers to the advertisement consumer's mobile device according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The following described exemplary embodiments of the invention can be applied to any and all types of information communication devices, and their applications that can be wirelessly or wiredly connected to networks, for example, Personal Computers (PCs), Personal Digital Assistants (PDAs), tablet PCs, mobile phones, smart phones, etc. More particularly, when the invention is applied to a mobile device such as a smart phone, the mobile device may include a Global Positioning System (GPS) receiver for detecting its current location and a map application for displaying its current location on the map.

In an exemplary embodiment of the invention, a server refers to a computer that can provide contents and services to clients, i.e., mobile devices, via a network.

In addition, a network includes the Internet and a mobile communication network. The Internet refers to a type of network that connects wirelessly or wiredly to computer networks spread over the world, and follows a communication protocol for example, Transmission Control Protocol/Internet Protocol (TCP/IP). Wireless Internet accesses are divided into a wireless Internet, mobile Internet (e.g., Wireless broadband (Wibro) or Worldwide Interoperability for Microwave Access (WiMax)), etc. Wireless interne allows mobile devices to connect to the Internet via a mobile communication network, based on platforms, such as a Wireless Application Protocol (WAP), Wireless Internet Platform for Interoperability (WIPI), etc., or via WiFi (or wireless Local Area Network (LAN)), an Assess Point (AP), etc. Mobile Internet (e.g., Wibro or WiMax) allows mobile devices to connect to a high speed Internet while they are stationary or moving at a low speed, while retaining the quality and cost of Asymmetric Digital Subscriber Line (ADSL) service. Mobile communication networks include base stations or base station controllers. Mobile communication networks also refer to networks that can support synchronous and asynchronous systems, Code Division Multiple Access (CDMA), Global System for Mobile Communications (GSM), 3^{rd} Generation (3G), 3.5^{th} Generation (3.5G), 4^{th} Generation (4G), etc.

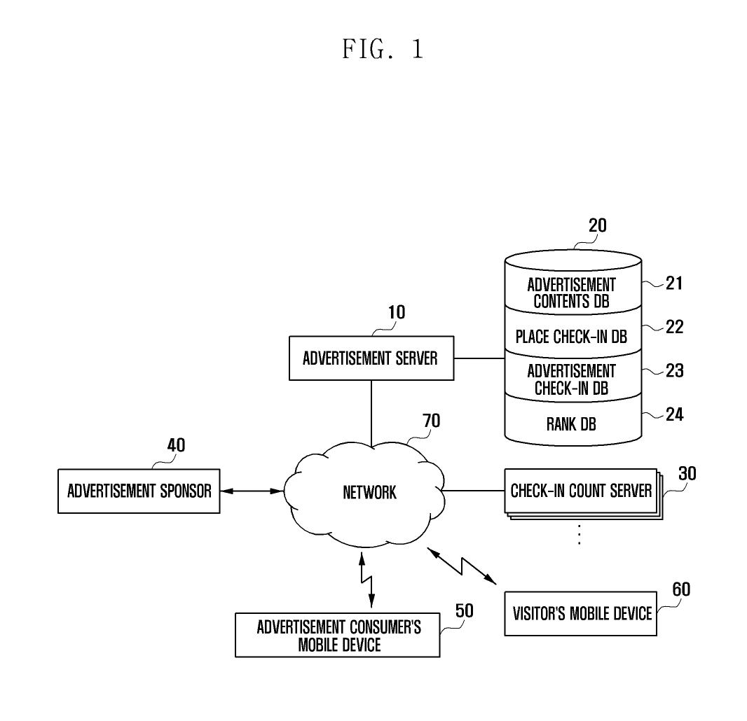

FIG. 1 illustrates a network configuration of a location-based advertisement contents providing system according to an exemplary embodiment of the present invention.

Referring to FIG. 1, the system includes an advertisement server 10, a database 20, one or more check-in count servers 30, an advertisement sponsor's mobile device 40, an advertisement consumer's mobile device 50, a visitor's mobile device 60, and a network 70 for connecting the components listed above.

Each check-in count server 30 identifies and counts check-ins based on physical places, transferred from the visitors' mobile devices 60, and stores the check-in counts in the database. The visitor's mobile device 60 refers to a mobile device to which a check-in application is installed. When a visitor checks in to his/her visited physical place, the visitor's mobile device 60 transfers the check-in to the check-in count server 30. The database of the check-in count server 30 is identified based on places, and includes a variety of fields, such as latitude and longitude, addresses, places, place identification, check-in counts, evaluation of a corresponding place, information regarding a mayor, etc. When the check-in count server 30 receives a request for check-in counts and places, etc., from the advertisement server 10, it distributes them free of charge via an open Application Programming Interface (API).

The advertisement server 10 stores the advertisement contents and the location information, transferred from the advertisement sponsor's mobile device 40, in an advertisement contents DB 21. The advertisement contents DB 21 is identified by advertisement contents. In addition, the advertisement server 10 receives the location information, transferred from the advertisement sponsor's mobile device 40, and transfers it to the check-in count server 30, so that it can request a place corresponding to the location, match the location with the place transferred from the check-in count server 30, and store them in the advertisement contents DB 21.

The advertisement server 10 transfers a place matched to the location to the check-in count server 30, thereby requesting a check-in count corresponding to the place. The advertisement server 10 receives the check-in count from the check-in count server 30 and stores it in a place check-in DB 22. When the advertisement server 10 receives a request transferred from an advertisement consumer's mobile device 50, it transfers the check-in count, stored in the place check-in DB 22, to the advertisement consumer's mobile device 50. The advertisement consumer can estimate the popularity and reliability of a corresponding place, via the place check-in counts, and can then determine whether he/she wishes to visit the place, use services provided by the place, purchase products sold at the place, etc. In an exemplary implementation, the advertisement server 10 can provide the check-in counts in a graph so that the user can immediately recognize the change in the counts as time elapses.

The advertisement server 10 can count check-in regarding advertisement contents from the advertisement consumer's mobile device 50, and can store the check-in counts in an advertisement check-in DB 23. When the advertisement server 10 receives a request from the advertisement consumer's mobile device 50, it can transfer the check-in count, stored in the check-in DB 23, to the advertisement consumer's mobile device 50. Therefore, the advertisement consumer can estimate the degree of other advertisement consumers' reactions regarding a corresponding advertisement, via the check-in count, and can then determine whether he/she wishes to visit the place corresponding to the advertisement, use services provided by the place, and purchase products sold at the place.

The advertisement server 10 can add the place check-in counts and the advertisement check-in counts and transfer the result to the advertisement consumer's mobile device 50. Alternatively, the advertisement server 10 can separately transfer the place check-in counts and the advertisement check-in counts to the advertisement consumer's mobile device 50. That is, when the advertisement server 10 ascertains that the advertisement check-in count serves as primary data that can estimate the objective reliability regarding the advertisement contents in the same manner as the place check-in count, it adds the advertisement check-in count and the place check-in count and transfers the result to the advertisement consumer's mobile device 50. On the contrary, when the advertisement check-in count serves only as supplementary data, the advertisement server 10 separately transfers the advertisement check-in count and the place check-in count to the advertisement consumer's mobile device 50. For example, when an advertisement consumer views an advertisement, visits a corresponding place, and purchases a product or views an advertisement, visits a website, and purchases a product on-line, a corresponding advertisement count may serve as data that is as important as the place check-in count. On the contrary, when an advertisement consumer only views an advertisement, a corresponding advertisement check-in count may serve only as supplementary data.

As an example of a case where the advertisement check-in count and the place check-in count are added, the advertisement server 10 assigns an authentication number to an advertisement consumer's mobile device 50 that checked in to advertisement contents. When the advertisement consumer visits a corresponding physical place and purchases a product, he/she can buy it at a discounted price by submitting an authentication number. When the advertisement server 10 receives the authentication number from the advertisement sponsor's mobile device 40 or a mobile device installed to a corresponding place, it counts the check-in related to a corresponding advertisement and stores the check-in count in the advertisement check-in DB 23. On the other hand, when the advertisement consumer purchases a product on-line, the advertisement server 10 regards the purchase process as a check-in, and counts the check-in. After that, the advertisement server 10 stores the check-in count in the advertisement check-in DB 23. In these cases described above, the advertisement server 10 adds the place check-in count and the advertisement check-in count, and transfers the added count to the advertisement consumer's mobile device 50.

The advertisement server 10 determines the ranks of check-in counts, stored in the place check-in DB 22, according to fields and local areas, and stores the determined rank in a rank DB 24. When the place check-in counts is the same as the advertisement check-in counts, the advertisement server 10 adds the two counts and may determine the rank using the added counts.

When the advertisement server 10 receives a request for a list of advertisement contents from the advertisement consumer's mobile device 50, it arranges the advertisement contents in ascending or descending order according to the rank and transmits it to the advertisement consumer's mobile device 50.

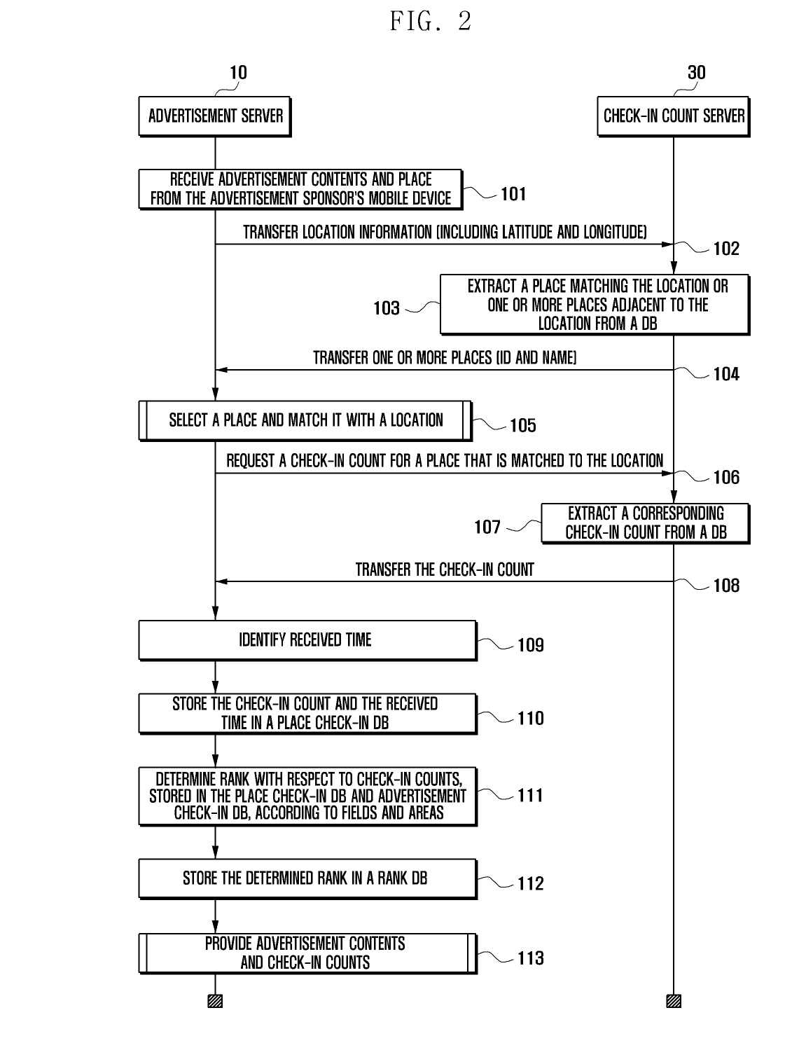

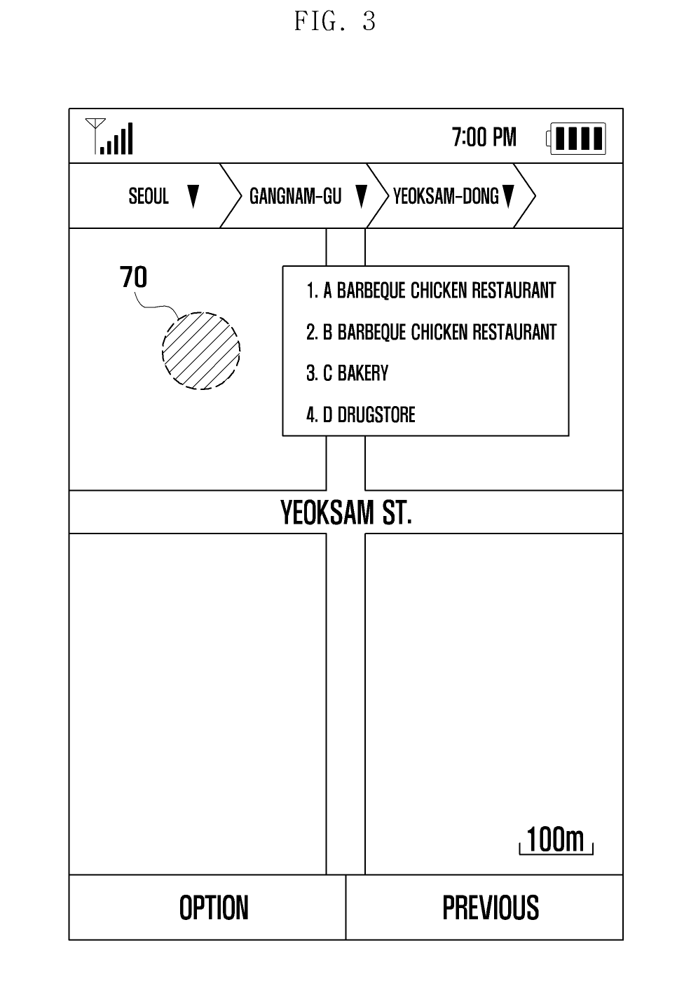

FIG. 2 illustrates a flowchart that describes a location-based advertisement contents providing method according to an exemplary embodiment of the present invention. FIG. 3 illustrates a screen of an advertisement sponsor's mobile device that describes a process of registering a location of advertisement contents to an advertisement server, according to an exemplary embodiment of the present invention.

Referring to FIG. 2, the advertisement server 10 receives advertisement contents and the location of the advertisement contents from the advertisement sponsor's mobile device 40 in step 101.

As an example of step 101, an advertisement sponsor executes a map application installed on his/her mobile device 40. In that case, the advertisement sponsor's mobile device 40 loads a map file from the memory, and displays a map that shows its current location or a sponsor's preset location. When the advertisement sponsor's mobile device 40 does not have a map file in the memory, it connects to a server that provides maps, downloads a corresponding map file, and displays a map. When the sponsor touches the touch screen of his/her mobile device 40, the advertisement sponsor's mobile device 40, as shown in FIG. 3, calculates a center point of a touch area 70, reads a location corresponding to the calculated center point from the map file, and transfers the read location to the advertisement server 10, together with advertisement contents stored in the memory. In an exemplary embodiment of the invention, the location includes latitude and longitude. The location also includes a name of a Point of Interest (POI) or a name of a place that the user directly inputs via the touch screen. The POI refers to primary facilities displayed on a map, for example, train stations, airports, bus terminals, hotels, buildings, theaters, etc. The POI may be displayed step by step according to the scales of a map, i.e., reduced scales. For example, buildings or theaters may be only displayed on a map drawn to a scale of more than 1:10,000. When a sponsor does not want a POI included in a map, i.e., the location of the advertisement contents is not a POI, the POI is excluded. More specifically, when one or more POIs are in the touch area 70, the advertisement sponsor's mobile device 40 shows a message asking whether to include the POIs in the area 70 on the display unit. When the sponsor selects one of the POIs, the name of the POI is included at the location. On the contrary, when the sponsor does not select any POI, the names of POIs are excluded from the location.

As another example of step 101, a sponsor inputs an address and a name of a place to his/her mobile device 40 via the touch screen. In that case, the advertisement sponsor's mobile device 40 reads a location corresponding to the address from a map file, and transfers the location to the advertisement server 10, together with advertisement contents stored in the memory.

After receiving the advertisement contents and the location at step 101, the advertisement server 10 transfers the location to the check-in count server 30 in step 102, thereby requesting a place corresponding to the location. The check-in count server 30 determines whether a place matching the location is stored in the database. The check-in count server 30 extracts a corresponding place from the database when a place matching the location is stored in the database or a place within a radius of 20 m from the location when a place matching the location is not stored in the database in step 103. The reason why a place matching to the location is not stored in the database is because an error occurs when a touch is not correctly performed or when the latitude and longitude transferred by the advertisement server 10 differ from those stored in the database, in terms of data format.

After extracting one or more places at step 103, the check-in count server 30 transfers one or more places to the advertisement server 10 in step 104.

Meanwhile, when the check-in count server 30 ascertains that there is no place within a radius of 20 m from the location, it notifies the advertisement server 10 that there is no place that the sponsor wants. When the advertisement sponsor's mobile device 40 receives the notification, it may perform a procedure to register a corresponding place in the check-in count server 30 before registering advertisement contents in the advertisement server 10.

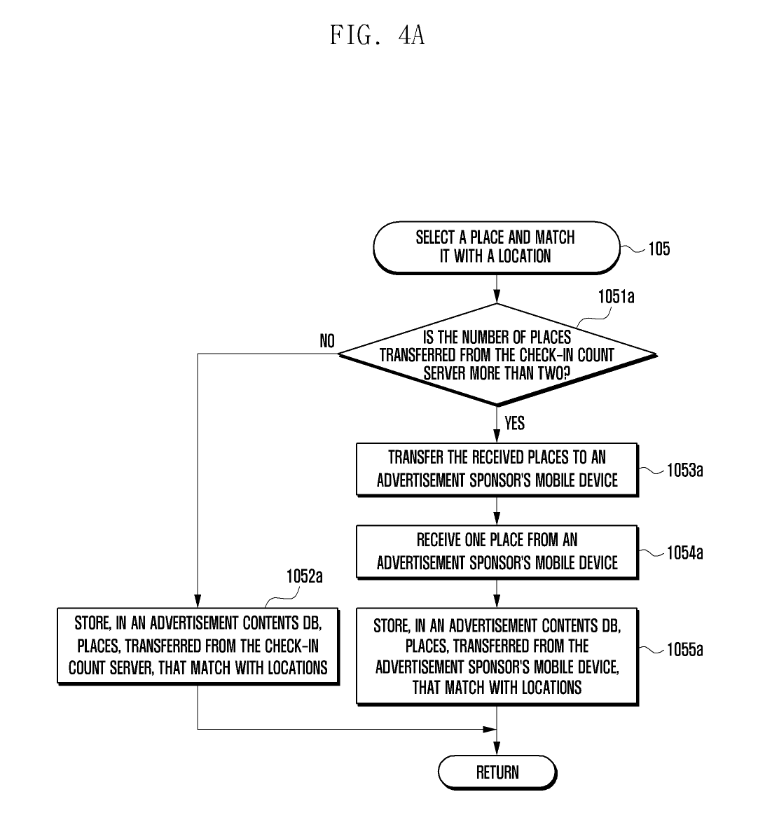

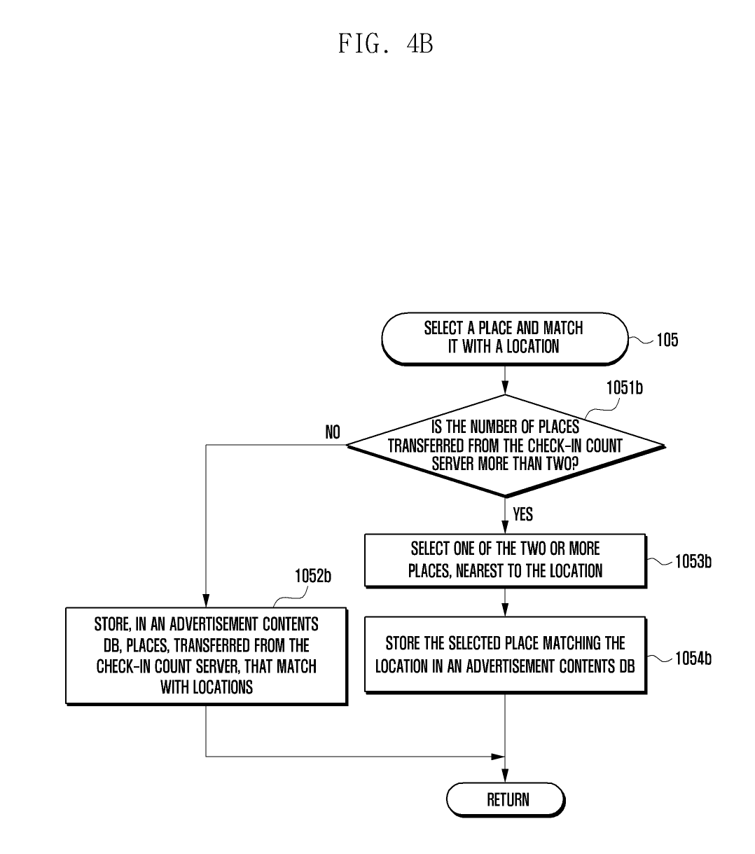

The advertisement server 10 selects one of the one or more places transferred from the check-in count server 30, matches the selected place with a location, and stores them in the advertisement contents DB 21 in step 105. Step 105 is described referring to FIG. 4A and FIG. 4B.

FIG. 4A illustrates a flowchart that describes an example of selecting and matching a place according to an exemplary embodiment of the present invention.

Referring to FIG. 4A, the advertisement sever 10 determines whether the number of places transferred from the check-in count server 30 is two or more in step 1051a. When the advertisement server 10 ascertains that the number of places is one at step 1051a, it matches the place with a location and stores them in the advertisement contents DB 21 in step 1052a. On the contrary, when the advertisement server 10 ascertains that the number of places is two or more at step 1051a, it transfers the places to the advertisement sponsor's mobile device 40 in step 1053a. In that case, the sponsor's mobile device 40 displays the places, via a pop-up window, on the display unit, as shown in FIG. 3. When the sponsor's mobile device 40 receives a touch signal via the touch screen, it transfers one place corresponding to the touch area to the advertisement server 10.

The advertisement server 10 receives the place, selected by the sponsor, from the advertisement sponsor's mobile device 40 in step 1054a. After that, the advertisement server 10 matches the selected place with a location, and stores them in the advertisement contents DB 21 in step 1055a. After that, the advertisement server 10 returns to step 106.

FIG. 4B illustrates a flowchart that describes another example of selecting and matching a place according to an exemplary embodiment of the present invention.

Referring to FIG. 4B, the advertisement sever 10 determines whether the number of places transferred from the check-in count server 30 is two or more in step 1051b. When the advertisement server 10 ascertains that the number of places is one at step 1051b, it matches the place with a location and stores them in the advertisement contents DB 21 in step 1052b. On the contrary, when the advertisement server 10 ascertains that the number of places is two or more at step 1051b, it selects one of the places closest to a location in step 1053b. After that, the advertisement server 10 matches the selected place with the location, and stores them in the advertisement contents DB 21 in step 1054b. After that, the advertisement server 10 returns to step 106.

Referring back to FIG. 2, the advertisement server 10 requests a check-in count of a place matching the place from the check-in count server 30, according to a preset period or policy, for example, once a day in step 106. The check-in count server 30 extracts a check-in count, requested by the advertisement server 10, from the database in step 107, and transfers it to the advertisement sever 10 in step 108.

The advertisement server 10 ascertains a receiving time of the check-in count from the check-in count server 30 in step 109. After that, the advertisement server 10 stores the check-in count and the receiving time in the place check-in DB 22 in step 110. The check-in count server 30 transfers only the check-in counts that are accumulated until the current time to the advertisement server 10, without transferring the check-in counts by time periods. Therefore, the reason why the advertisement server 10 ascertains the receiving time and stores it is to calculate the check-in counts by time periods and to provide the calculated check-in counts to the advertisement consumer's mobile device 50.

The advertisement server 10 determines the rank of the check-in counts, stored in the place check-in DB 22 and advertisement check-in DB 23, according to fields and local areas in step 111. After that, the advertisement server 10 stores the rank of the check-in counts determined according to fields and local areas in the rank DB 24 in step 112. In an exemplary embodiment of the invention, the rank may be determined according to the order of check-in counts accumulated until the current time or according to the order of check-in counts accumulated during a period of time, for example, in the last month.

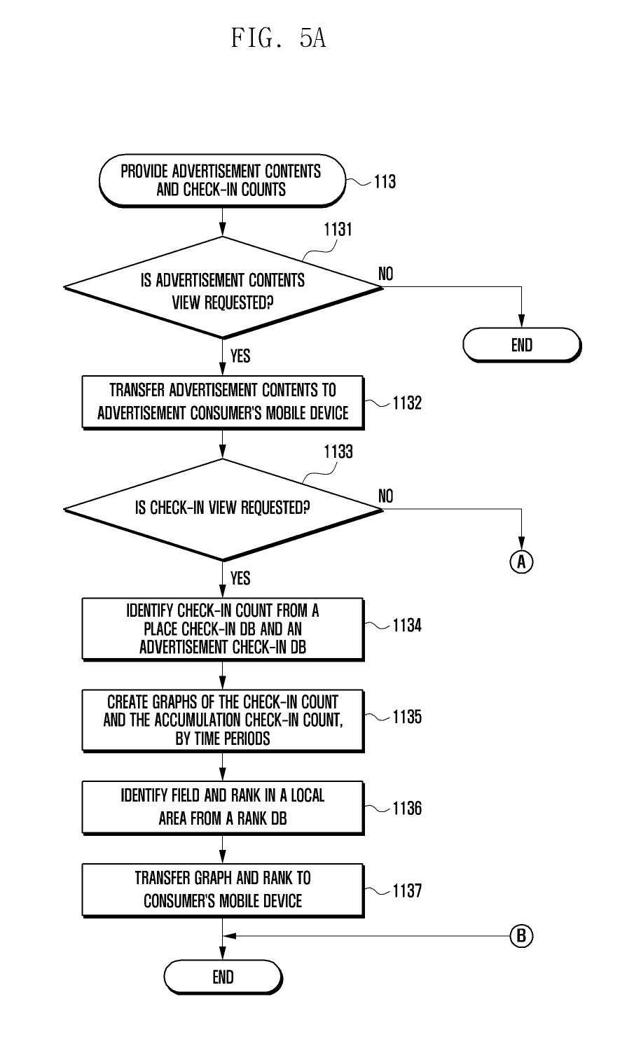

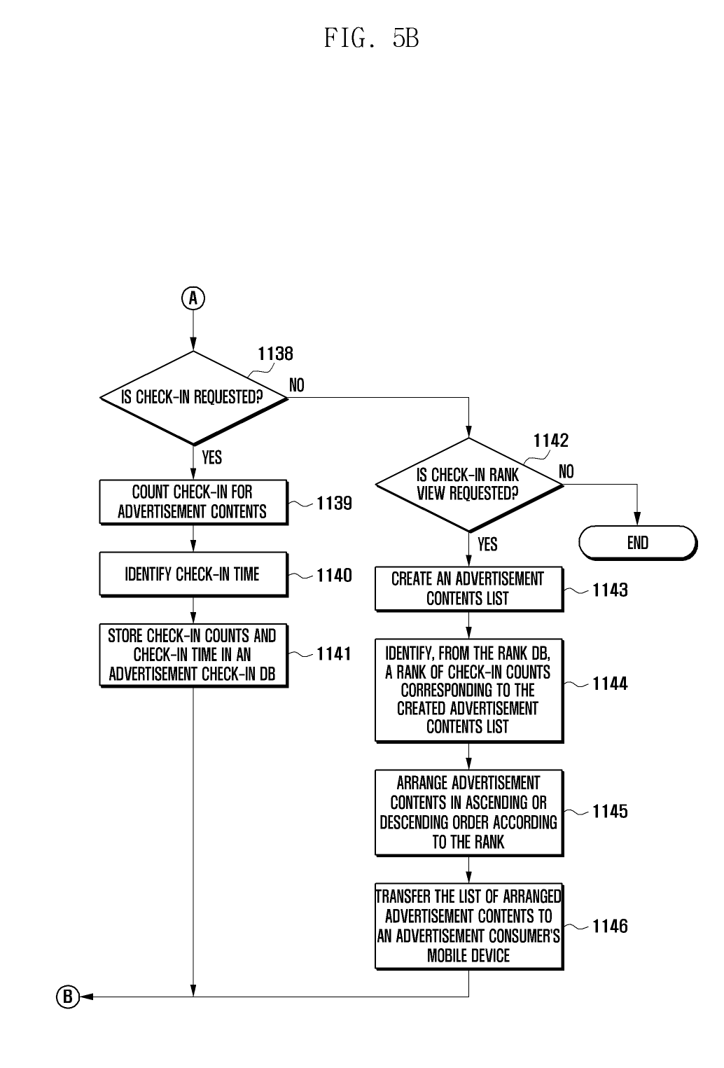

When the advertisement server 10 receives a request for advertisement contents and check-in counts from the advertisement consumer's mobile device 50, it transfers them to the advertisement consumer's mobile device 50 in step 113. Step 113 is described in more detail with reference to FIGS. 5A and 5B.

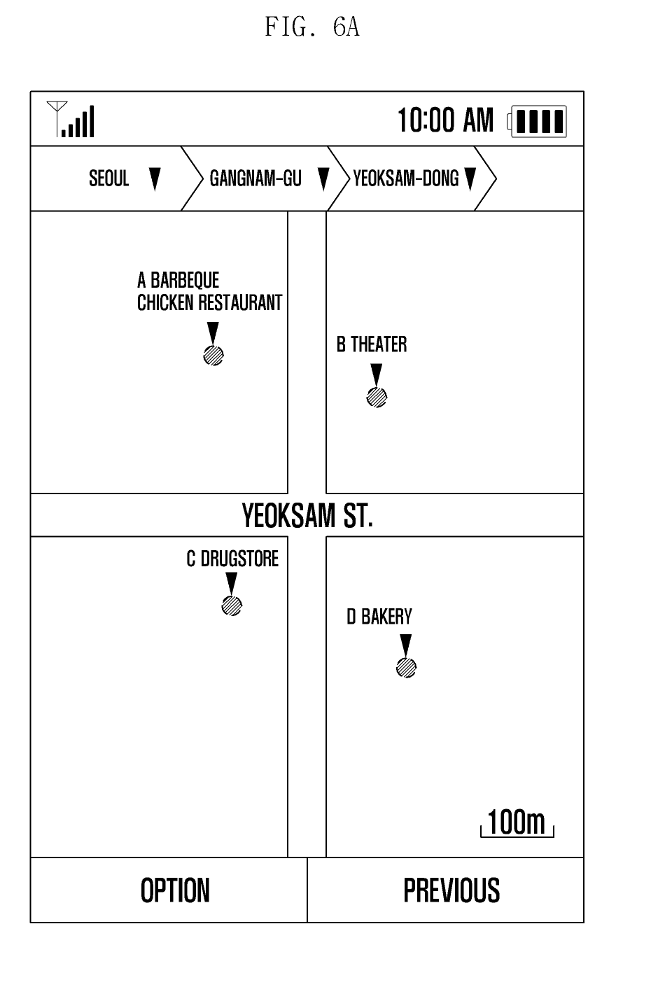

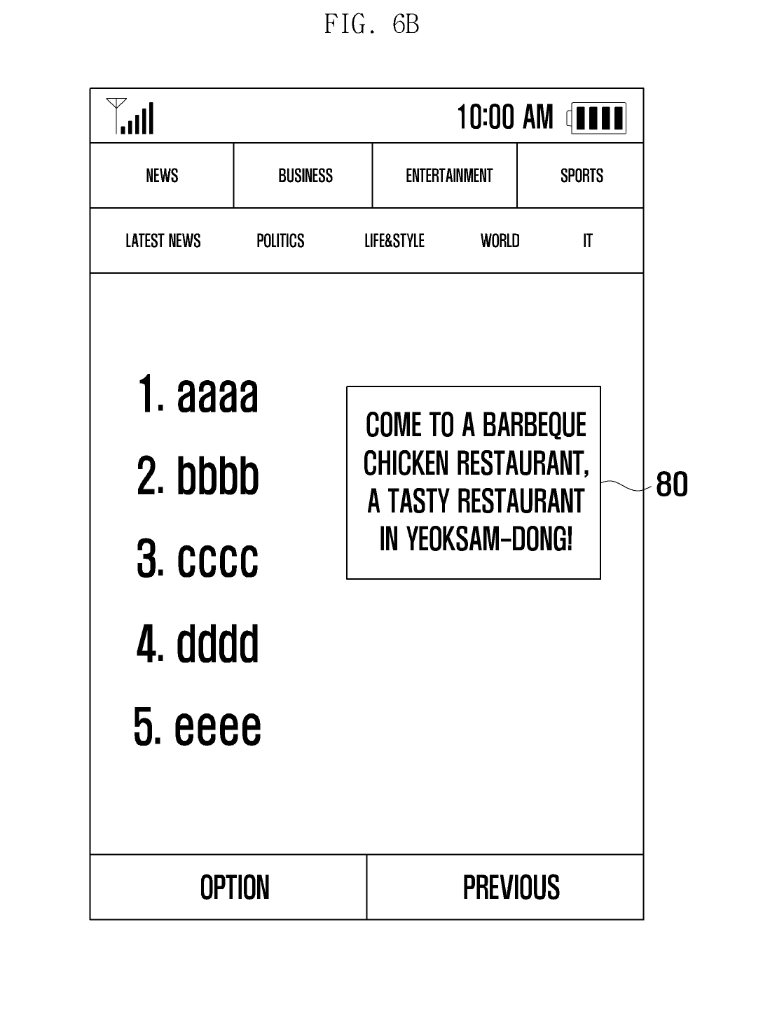

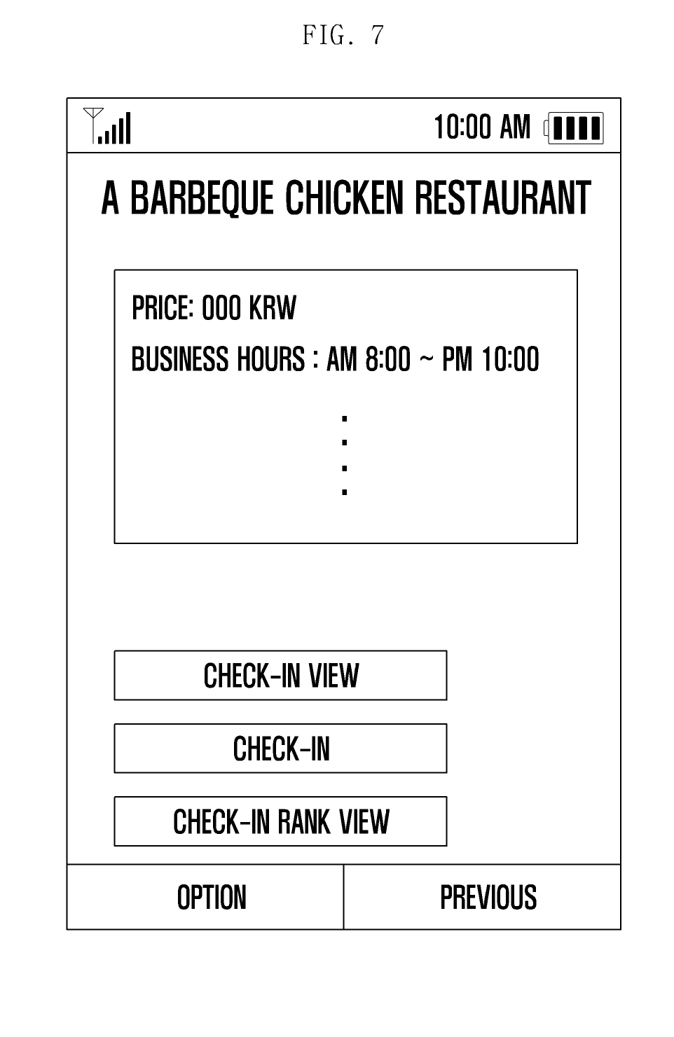

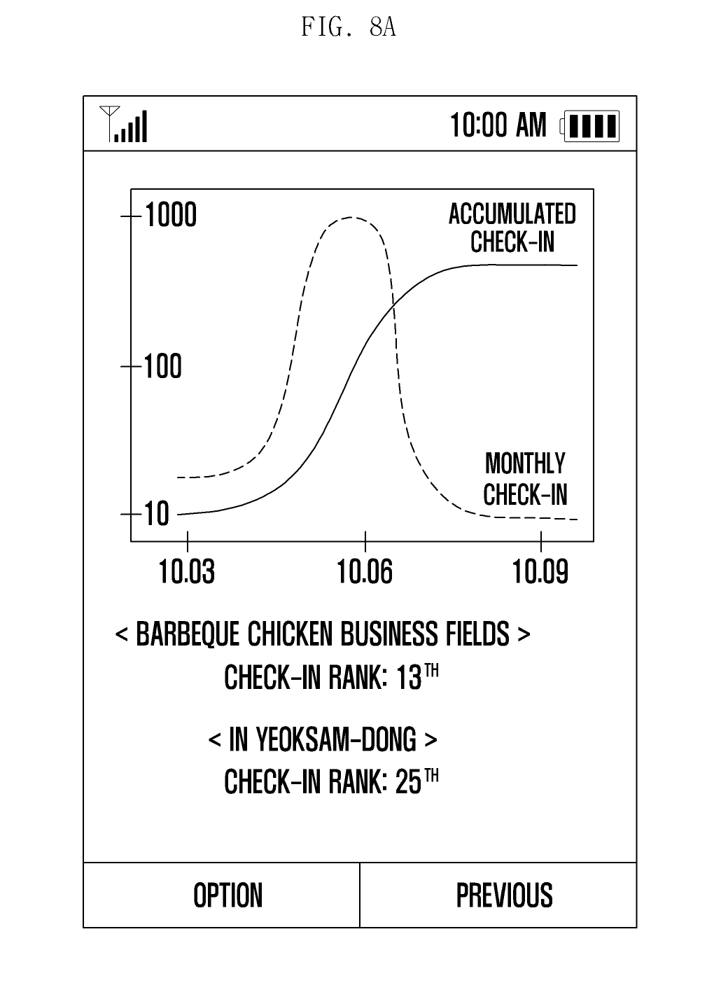

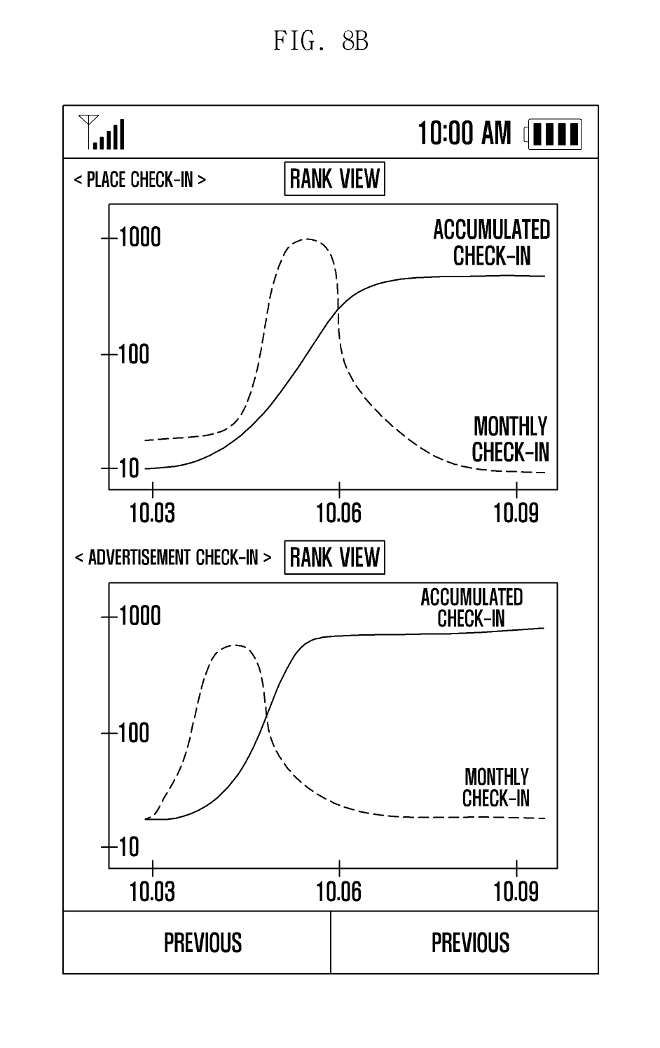

FIGS. 5A and 5B illustrate a flowchart that describes providing advertisement contents and check-in counts according to an exemplary embodiment of the present invention. FIG. 6A illustrates a screen of an advertisement consumer's mobile device that describes an example of requesting an advertisement contents view according to an exemplary embodiment of the present invention. FIG. 6B illustrates a screen of an advertisement consumer's mobile device that describes another example of requesting an advertisement contents view according to an exemplary embodiment of the present invention. FIG. 7 illustrates a screen of an advertisement consumer's mobile device that describes requesting a check-in view and a check-in according to an exemplary embodiment of the present invention. FIGS. 8A and 8B illustrate a screen of an advertisement consumer's mobile device, displaying a check-in count that an advertisement server transfers to the advertisement consumer's mobile device according to an exemplary embodiment of the present invention.

Referring to FIG. 5A, an advertisement consumer executes a map application installed on his/her mobile device 50. The advertisement consumer's mobile device 50 reads its current location or a map surrounding the consumer's preset location from a map file and displays it. When the map file does not have the map, the advertisement consumer's mobile device 50 downloads the map from a server that provides map information, and displays it. As shown in FIG. 6A, the advertisement consumer's mobile device 50 displays marks representing advertisement contents on the map. When the advertisement consumer touches one of the marks, the consumer's mobile device 50 requests advertisement contents corresponding to the selected mark from the advertisement server 10.

Alternatively, the advertisement consumer may execute a browser installed on his/her mobile device 50. In that case, the consumer's mobile device 50 connects to a portal website, for example, and downloads and displays a web page containing a banner advertisement 80, as shown in FIG. 6B. When the consumer touches the banner advertisement, the consumer's mobile device 50 requests advertisement contents corresponding to the banner advertisement from the advertisement server 10.

The advertisement server 10 determines whether to receive a request to view advertisement contents from the advertisement consumer's mobile device 50 in step 1131. When the advertisement server 10 ascertains that the advertisement consumer's mobile device 50 requests to view advertisement contents at step 1131, it transfers advertisement contents to the advertisement consumer's mobile device 50 in step 1132. The advertisement consumer's mobile device 50 displays advertisement contents as shown in FIG. 7. After viewing the advertisement contents, the advertisement consumer may view the check-in count of the corresponding advertisement contents by selecting a ‘check-in’ icon on the display unit, may check-in to the corresponding advertisement contents by selecting a ‘check-in’ icon, or may view the rank of the list of advertisement contents containing the corresponding advertisement contents by selecting a ‘check-in rank view’ icon.

The advertisement server 10 determines whether the advertisement consumer's mobile device 50 requests a check-in view in step 1133. When the advertisement server 10 ascertains that the advertisement consumer's mobile device 50 requests a check-in view at step 1133, it identifies the check-in count and the receiving time of the corresponding advertisement contents from the place check-in DB 22 and advertisement check-in DB 23 in step 1134. After that, the advertisement server 10 creates graphs of the check-in count and the accumulation check-in count, by time periods, as shown in FIGS. 8A and 8B, in step 1135. That is, the advertisement server 10 calculates the check-in counts accumulated according to time periods, for example, monthly, using the check-in counts and their receiving time, and creates a graph of the calculated check-in counts by time periods. Alternatively, the advertisement server 10 arranges the check-in counts in order according to the receiving time, and creates a graph of the arranged check-in counts. The advertisement server 10 may create a graph of the check-in counts, stored in the place check-in DB 22, and a graph of the check-in counts stored in the advertisement check-in DB 23, respectively, as shown in FIG. 8B. Alternatively, the advertisement server 10 may create a graph corresponding to the addition of the check-in counts, stored in the place check-in DB 22, and the check-in counts stored in the advertisement check-in DB 23, as shown in FIG. 8A. The determination has already been described in the earlier part as to whether the place check-in counts and the advertisement check-in counts are added to each other or separated. In addition, when the advertisement server 10 ascertains that the advertisement check-in count is only supplementary data, it may not create a graph of the advertisement check-in count.

The advertisement server 10 ascertains the rank of the advertisement contents corresponding to the graph in the field and the local area of the advertisement contents from the rank DB 24 in step 1136. After that, the advertisement server 10 transfers the graph of the rank to the advertisement consumer's mobile device 50 in step 1137.

Meanwhile, when the advertisement server 10 ascertains that the advertisement consumer's mobile device 50 does not request a check-in view at step 1133, it determines whether the advertisement consumer's mobile device 50 requests a check-in process in step 1138. When the advertisement server 10 ascertains that the advertisement consumer's mobile device 50 requests a check-in process at step 1138, it counts the check-in regarding the corresponding advertisement contents in step 1139. It is preferable that the advertisement server 10 counts the advertisement check-in, only if it receives an authentication number from an advertisement sponsor's mobile device 40 or an advertisement consumer purchases a product on-line, than unconditionally counting the check-in although the advertisement consumer's mobile device 50 requests a request for an advertisement check-in count.

The advertisement server 10 ascertains the time when the advertisement check-in is counted in step 1140, and stores the time and the advertisement check-in counts in the advertisement check-in DB 23 in step 1141.

On the contrary, when the advertisement server 10 ascertains that the advertisement consumer's mobile device 50 does not request a check-in process at step 1138, it determines whether the advertisement consumer's mobile device 50 requests to view a check-in rank in step 1142. When the advertisement server 10 ascertains that the advertisement consumer's mobile device 50 requests to view a check-in rank at step 1142, it creates a list of advertisement contents in step 1143. In more detail, the advertisement server 10 ascertains the field and local area corresponding to the received advertisement contents. The local area may be an area within a radius of 100 meters from the location of the advertisement contents that the consumer's mobile device 50 received at step 1132 or an administrative district area that the location of the advertisement contents that the consumer's mobile device 50 received at step 1132 belongs to. After that, the advertisement server 10 extracts the advertisement contents in the ascertained local area from the advertisement contents DB 21. The advertisement sever 10 also extracts the advertisement contents in the ascertained field from the advertisement contents DB 21. Alternatively, the advertisement server 10 may only extract advertisement contents that correspond to both the local area and the field from the advertisement contents DB 21. After that, the advertisement server 10 creates lists of extracted advertisement contents by local areas and fields, respectively. Alternatively, the advertisement server 10 may create a list of advertisement contents that correspond to both the local area and the field.

The advertisement server 10 ascertains the rank of the check-in counts corresponding to the created list of advertisement contents via the rank DB 24 in step 1144. The advertisement server 10 arranges the advertisement contents in ascending or descending order according to the ascertained rank in step 1145. The advertisement server 10 transfers the list of arranged advertisement contents to the advertisement consumer's mobile device 50 in step 1146.

As described above, the location-based advertisement contents providing method and system according to exemplary embodiments of the invention can provide, to advertisement consumers, the check-in counts of a physical place corresponding to advertisement contents, serving as data to evaluate the reliability of the physical place, instead of providing subjective evaluation points according to conventional art, thereby enhancing the reliability of the advertisement contents.

The location-based advertisement contents providing method and system according to the invention can provide data that can evaluate the reliability of advertisement contents from the beginning, compared with conventional arts that evaluate the reliability from the evaluation point ‘0’ which requires a great deal of time.

In an exemplary implementation, the location-based advertisement contents providing method and system provides the check-in counts in graph form, so that advertisement consumers can easily see the trend of change in the counts of corresponding advertisement contents.

The location-based advertisement contents providing method and system according to exemplary embodiments of the invention can provide the rank of advertisement contents in the field or the local area to the advertisement consumers. They can also arrange the list of advertisement contents in ascending or descending order according to the rank and provide it to the advertisement consumers. Therefore, the consumers can recognize the relative rank between the advertisement contents and select corresponding advertisement contents with a high degree of reliability.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for providing location-based advertisement contents from an advertisement server to an advertisement consumer's mobile device via a network, the method comprising:
receiving, by the advertisement server, check-in counts accumulated as visitors visit a place and check in to the place, and storing them in a place check-in database (DB);
extracting, by the advertisement server, a check-in count of a corresponding place corresponding to a location of the advertisement contents from the place check-in DB when the advertisement consumer's mobile device requests advertisement contents and the check-in count from the advertisement server; and
transferring, by the advertisement server, the advertisement contents and the extracted check-in count to the advertisement consumer's mobile device.

2. The method of claim 1, wherein the storing of the accumulated check-in counts in the place check-in DB comprises:
requesting a check-in count of a place corresponding to a location of the advertisement contents from a check-in count server;
receiving the requested check-in count from the check-in count server; and
storing the received check-in count and a receiving time of the check-in count in the place check-in DB, wherein
the check-in count is created as the check-in count server counts the check-in transferred from a mobile device of a visitor who visited the place.

3. The method of claim 2, wherein the transferring of the advertisement contents and the extracted check-in count to the advertisement consumer's mobile device comprises:
calculating check-in counts by time periods, using a number of check-in counts and time receiving the check-in stored in the place check-in DB; and
transferring the check-in counts by time periods to the advertisement consumer's mobile device.

4. The method of claim 3, further comprising:
creating a graph of the check-in counts by time periods.

5. The method of claim 2, wherein the transferring of the advertisement contents and the extracted check-in count to the advertisement consumer's mobile device comprises:
arranging a number of check-in counts, stored in the place check-in DB, according to the receiving time;
creating a graph of the arranged check-in counts; and
transferring the graph to the advertisement consumer's mobile device.

6. The method of claim 2, further comprising:
transferring, when receiving the location from a mobile device of an advertisement sponsor, the location to the check-in count server;
receiving a number of places from the check-in count server that received the location;
transferring the number of places, transferred from the check-in count server, to the advertisement sponsor's mobile device;
matching, when the advertisement sponsor selects one of the number of places, the selected place with the location; and
requesting a check-in count of a place matching the location from the check-in count server.

7. The method of claim 2, further comprising:
transferring, when receiving the location from a mobile device of an advertisement sponsor, the location to the check-in count server;
receiving a number of places from the check-in count server that received the location;
selecting one of the number of places, closest to the position;
matching the selected place with the location; and
requesting a check-in count of a place matching the location from the check-in count server.

8. The method of claim 2, further comprising:
determining ranks of a number of check-in counts, stored in the place check-in DB, according to fields or local areas;
storing the ranks of check-in counts determined according to fields or local areas in a rank DB; and
ascertaining a rank of a check-in count of a place corresponding to the location from the rank DB,
wherein the transferring of the advertisement contents and the extracted check-in count comprises transferring the check-in count of a place corresponding to the location and the ascertained rank to the advertisement consumer's mobile device.

9. The method of claim 8, further comprising:
arranging a list of advertisement contents in ascending or descending order according to the rank determined by fields or local areas, and transferring the list of arranged advertisement contents to the advertisement consumer's mobile device.

10. The method of claim 2, further comprising:
receiving a check-in regarding the advertisement contents from the advertisement consumer's mobile device; and
counting the received check-in and storing the check-in count in an advertisement check-in DB,
wherein the transferring of the advertisement contents and the extracted check-in count comprises adding a check-in count, stored in the place check-in DB, and a check-in count stored in the advertisement check-in DB and transferring the added check-in count to the advertisement consumer's mobile device or separately transferring them.

11. A method for providing location-based advertisement contents from an advertisement server to an advertisement consumer's mobile device via a network, the method comprising:
requesting a check-in count of a place corresponding to a location of advertisement contents from a check-in count server that counts a check-in transferred from a mobile device of a visitor;
storing the check-in count, transferred from the check-in count server, in a place check-in database (DB);
determining ranks of a number of check-in counts, stored in the place check-in DB, according to fields or local areas; and
arranging a list of advertisement contents in ascending or descending order according to the rank determined by fields or local areas, and transferring the list of arranged advertisement contents to the advertisement consumer's mobile device,
wherein, when the visitor checks in to his/her visited place, the visitor's mobile device transfers the check in to the check-in count server.

12. A system for providing location-based advertisement contents to an advertisement consumer's mobile device via a network, the system comprising:
an advertisement server for requesting a check-in count of a place corresponding to a location of advertisement contents from a check-in count server, and for transferring the check-in count, transferred from the check-in count server, and the advertisement contents to the advertisement consumer's mobile device; and
a database (DB) server including an advertisement contents DB for storing the advertisement contents, and a place check-in DB for storing the check-in counts transferred from the check-in count server, wherein,
the check-in count sever counts check-ins transferred from a mobile device of a visitor, and
the visitor's mobile device transfers, when the visitor checks in to his/her visited place, the check in to the check-in count server.

13. The system of claim 12, wherein:
the DB server stores the received check-in count and a receiving time of the check-in count in the place check-in DB; and
the advertisement server calculates check-in counts by time periods, using a number of check-in counts and time of receiving the check-in stored in the place check-in DB, and transfers the check-in counts by time periods to the advertisement consumer's mobile device.

14. The system of claim 13, wherein the advertisement server creates a graph of the check-in counts by time periods and transfers the graph to the advertisement consumer's mobile device.

15. The system of claim 12, wherein:
the DB server sores the received check-in count and a receiving time of the check-in count in the place check-in DB; and
the advertisement server arranges a number of check-in counts, stored in the place check-in DB, according to the receiving time, creates a graph of the arranged check-in counts, and transfers it to the advertisement consumer's mobile device.

16. The system of claim 12, wherein the advertisement server:
transfers, when receiving the location from a mobile device of an advertisement sponsor, the location to the check-in count server;
receives a number of places from the check-in count server that received the location;
transfers the number of places, transferred from the check-in count server, to the advertisement sponsor's mobile device;
matches, when the advertisement sponsor selects one of the number of places, the selected place with the location; and
requests a check-in count of a place matching the location from the check-in count server.

17. The system of claim 12, wherein the advertisement server:
transfers, when receiving the location from a mobile device of an advertisement sponsor, the location to the check-in count server;
receives a number of places from the check-in count server that received the location;
selects one of the number of places, closest to the position;
matches the selected place with the location; and
requests a check-in count of a place matching the location from the check-in count server.

18. The system of claim 12, wherein the advertisement server:
stores check-in counts, transferred from the check-in count server, in the check-in DB;
determines ranks of a number of check-in counts, stored in the place check-in DB, according to fields or local areas;
stores the ranks of check-in counts determined according to fields or local areas in a rank DB of the DB server;
ascertains a rank of a check-in count of a place corresponding to the location from the rank DB; and
transfers the check-in count of a place corresponding to the location and the ascertained rank to the advertisement consumer's mobile device.

19. The system of claim 18, wherein the advertisement server arranges a list of advertisement contents in ascending or descending order according to the rank determined by fields or local areas, and transfers the list of arranged advertisement contents to the advertisement consumer's mobile device.

20. The system of claim 12, wherein the advertisement server:
stores the check-in count, transferred from the check-in count server, in the place check-in DB;
receives a check-in regarding the advertisement contents from the advertisement consumer's mobile device;
counts the check-in, transferred from the advertisement consumer's mobile device, and store the check-in count in an advertisement check-in DB of the DB server; and
adds a check-in count, stored in the place check-in DB, and a check-in count stored in the advertisement check-in DB and transfers the added check-in count to the advertisement consumer's mobile device or separately transfers them.
